(19) United States
(12) Patent Application Publication
(10) Pub. No.: US 2017/0344511 A1
(43) Pub. Date: Nov. 30, 2017

(54) APPARATUS ASSIGNING CONTROLLER AND DATA SHARING METHOD

(71) Applicant: H3 Platform, Inc., New Taipei City (TW)

(72) Inventor: Yu-Ching Chou, New Taipei City (TW)

(73) Assignee: H3 Platform, Inc., New Taipei City (TW)

(21) Appl. No.: 15/263,372

(22) Filed: Sep. 13, 2016

(30) Foreign Application Priority Data
May 31, 2016 (TW) 105117069

(51) Int. Cl. G06F 13/42; G06F 13/40

(52) U.S. Cl. CPC G06F 13/4282; G06F 13/4022; G06F 2213/0026

(57) ABSTRACT

An apparatus assigning controller is provided. The apparatus assigning controller includes a communication interface and a routing apparatus. The communication interface is configured to respectively connect to a plurality of external servers. The routing apparatus is connected to the communication interface. The routing apparatus is configured to provide a data transfer path between the plurality of servers, so as to connect the routing apparatus to the plurality of servers through the communication interface. The plurality of servers share data with each other via the routing apparatus according to a peripheral component interconnect express (PCI Express) communication protocol. A data sharing method is also provided.

### CROSS-REFERENCE TO RELATED APPLICATION

This application claims the priority benefit of Taiwan application serial no. 105117069, filed on May 31, 2016. The entirety of the above-mentioned patent application is hereby incorporated by reference herein and made a part of this specification.

### BACKGROUND OF THE INVENTION

### Field of the Invention

The invention relates to a data transmission technique, and particularly relates to an apparatus assigning controller having a data sharing function in a peripheral component interconnect express (PCIe) communication protocol and a data sharing method.

### Description of Related Art

Along with development of cloud network technology, due to establishment of a cloud computing center, demands on computation and data access are increased, the cloud computing center may include a plurality of servers and a plurality of peripheral devices, where each server may include a memory/storage device.

It should be noted that in the storage device of the server, the server may store a large amount of data information. Data information transfer or access between the servers is generally implemented through an Internet switch. Namely, when the servers want to share data, a local area network has to be established according to a transmission control protocol/Internet protocol (TCP/IP) to implement data information transmission.

However, when the servers adopt the TCP/IP communication protocol to share the data information, each server has to additionally set a network card, a network hole, etc., and cannot transmit or share data with each other through other communication protocol. Therefore, how to effectively transmit data between the servers and decrease a construction cost of the cloud computing center becomes important issues in construction of the cloud computing center and in a data sharing technique between the servers.

### SUMMARY OF THE INVENTION

The invention is directed to an apparatus assigning controller and a data sharing method, where the apparatus assigning controller is connected to a plurality of servers to facilitate the servers sharing data with each other according to a peripheral component interconnect express (PCIe) communication protocol, so as to effectively improve a transmission rate and a bandwidth of data information transmitted between the servers.

The invention provides an apparatus assigning controller including a communication interface and a routing apparatus. The communication interface is configured to respectively connect a plurality of external servers. The routing apparatus is connected to the communication interface. The routing apparatus is configured to provide a data transfer path between the servers, so as to connect the routing apparatus to the servers through the communication interface. The servers share data with each other via the routing apparatus according to a peripheral component interconnect express (PCIe) communication protocol.

In an embodiment of the invention, the routing apparatus includes a network interface card direct memory access module. The servers respectively include an access driving module. The access driving module is configured to connect the network interface card direct memory access module of the routing apparatus, so as to execute a data sharing operation between the servers according to the PCIe communication protocol.

In an embodiment of the invention, the network interface card direct memory access module and the access driving modules package data information to be shared into network protocol data information according to the PCIe communication protocol, and transmit bus packet-type data information according to the PCIe communication protocol.

In an embodiment of the invention, the routing apparatus is a PCIe apparatus. The PCIe apparatus is configured to perform data transmission of at least one data information with the communication interface according to an Internet protocol and the PCIe communication protocol.

In an embodiment of the invention, the communication interface and the servers transmit data information according to the PCIe communication protocol.

In an embodiment of the invention, the routing apparatus packages data of an Internet protocol in the PCIe communication protocol, such that the data is adapted to be transmitted from one server to another server in a network formed according to the PCIe communication protocol.

In an embodiment of the invention, the apparatus assigning controller is connected to another apparatus assigning controller through the communication interface, and the servers perform data transmission of at least one data information with the another apparatus assigning controller through the apparatus assigning controller.

In an embodiment of the invention, the routing apparatus is connected to a routing apparatus of the another apparatus assigning controller, and is configured to provide another data transfer path between the servers and a plurality of servers of the another apparatus assigning controller, and the servers perform data transmission of at least one data information according to an Internet protocol address of the routing apparatus and an Internet protocol address of the routing apparatus of the another apparatus assigning controller.

In an embodiment of the invention, the servers and the servers of the another apparatus assigning controller share data with each other through the routing apparatus and the routing apparatus of the another apparatus assigning controller according to the PCI communication protocol.

In an embodiment of the invention, the servers and the servers of the another apparatus assigning controller share data with each other through a port mapping function between the apparatus assigning controller and the another apparatus assigning controller.

The invention provides a data sharing method adapted to an apparatus assigning controller including a communication interface and a routing apparatus. The data sharing method includes following steps: respectively connecting a plurality of external servers through the communication interface, such that the routing apparatus is connected to the servers through the communication interface; and, sharing data by the servers via the routing apparatus according to a peripheral component interconnect express (PCIe) communication protocol.

In an embodiment of the invention, the step of executing the data sharing operation between the servers according to the PCIe communication protocol includes following steps: packaging data information to be shared into packet-type data information according to an Internet protocol, and the packet-type data information is packaged into PCIe-type data information according to the PCIe communication protocol.

In an embodiment of the invention, the routing apparatus is a PCIe apparatus, and is configured to transfer at least one data information between the servers according to an Internet protocol and the PCIe communication protocol.

In an embodiment of the invention, the data sharing method further includes a following step: connecting another apparatus assigning controller through the communication interface, and the servers perform data transmission of at least one data information with the another apparatus assigning controller through the apparatus assigning controller.

In an embodiment of the invention, the step of connecting the another apparatus assigning controller through the communication interface includes a following step: performing data transmission of the at least one data information according to an Internet protocol address of the routing apparatus and an Internet protocol address of the routing apparatus of the another apparatus assigning controller.

In an embodiment of the invention, the step of performing data transmission of the at least one data information includes a following step: sharing data through the routing apparatus and the routing apparatus of the another apparatus assigning controller according to the PCI communication protocol.

In an embodiment of the invention, the step of performing data transmission of the at least one data information includes a following step: sharing data through a port mapping function between the apparatus assigning controller and the another apparatus assigning controller.

According to the above description, the apparatus assigning controller of the invention may provide a data transfer path for sharing data between the servers according to the PCIe communication protocol. Therefore, the servers may drive or connect the network interface card direct memory access module of the routing apparatus by using the access driving modules, and package the data information to be shared into the PCIe-type data information to implement data information sharing. In other words, it is unnecessary to additionally set related hardware (for example, a network card, a network hole) of the Internet protocol between the servers to implement data transmission, but the apparatus assigning controller is directly adopted to transmit data according to the PCIe communication protocol, so as to save construction of related hardware of the Internet protocol in the servers, and since a transmission rate of the PCIe communication protocol is faster than a transmission rate of the Internet protocol, the transmission rate and bandwidth of data information transmitted between the servers are effectively enhanced. Moreover, the apparatus assigning controller of the invention can be further connected to another apparatus assigning controller, such that the servers corresponding to the apparatus assigning controller or the another apparatus assigning controller may share data with each other.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus assigning controller according to an embodiment of the invention.

FIG. 2 is a schematic diagram of an example of an apparatus assigning controller according to an embodiment of the invention.

FIG. 3 is a block diagram of an apparatus assigning controller according to another embodiment of the invention.

FIG. 4 is a schematic diagram of an example of an apparatus assigning controller according to another embodiment of the invention.

FIG. 5 is a flowchart illustrating a data sharing method according to an embodiment of the invention.

FIG. 6 is a block diagram of an apparatus assigning controller according to still another embodiment of the invention.

### DESCRIPTION OF EMBODIMENTS

In the embodiments of the invention, an apparatus assigning controller and a peripheral component interconnect express (PCIe) communication protocol are adopted to provide a data sharing function between servers, such that a data sharing operation between the servers can be implemented through a routing apparatus in the apparatus assigning controller without additionally setting related hardware (for example, a network card, a network hole) of an Internet protocol. Since a transmission rate of the PCIe communication protocol is faster than a transmission rate of the Internet protocol, compared to the transmission method of the Internet protocol, the embodiment of the invention may provide a faster transmission speed and a larger bandwidth for data information transmitted between the servers, and may save construction of related hardware of the Internet protocol in the servers. Moreover, based on the aforementioned data transmission features, the apparatus assigning controller of the invention can be further connected to another apparatus assigning controller, such that the servers may share data information with each other according to the PCIe communication protocol and/or through a port mapping function between the apparatus assigning controller and the another apparatus assigning controller.

A term “couple (or connect)” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

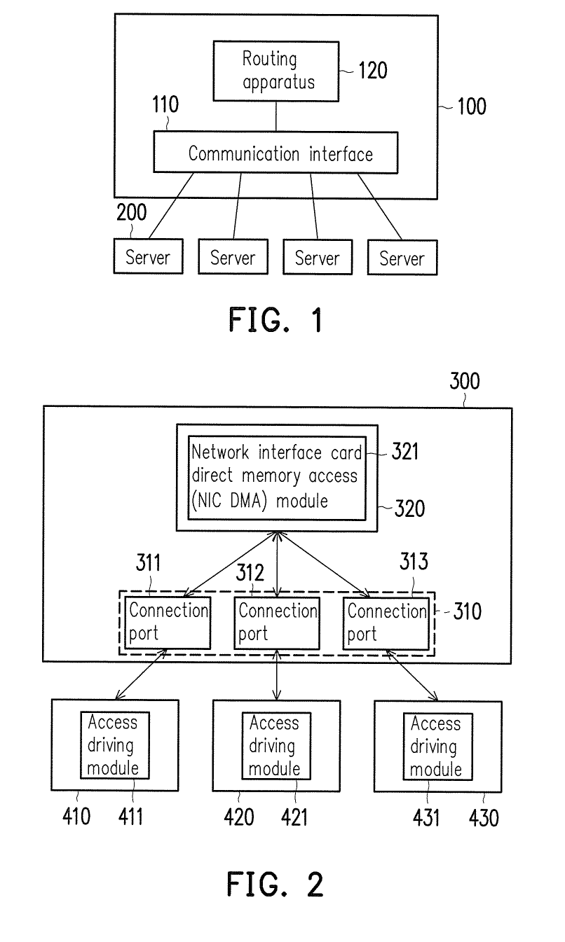

FIG. 1 is a block diagram of an apparatus assigning controller according to an embodiment of the invention. Referring to FIG. 1, the apparatus assigning controller 100 includes a communication interface 110 and a routing apparatus 120. The communication interface 110 is configured to respectively connect a plurality of external servers 200. The routing apparatus 120 is connected to the communication interface 110. The routing apparatus 120 is configured to provide a data transfer path between the servers 200, so as to connect the routing apparatus 120 to the servers 200 through the communication interface 110. Therefore, the servers 200 may share data with each other via the routing apparatus 120 according to a peripheral component interconnect express (PCIe) communication protocol. In the present embodiment, the apparatus assigning controller 100 is capable of dynamically assigning a plurality of peripheral devices to a physical server 200 or a plurality of virtual machines (VM) in the physical server 200. The servers of the present embodiment are all physical servers. It should be noted that in the present embodiment, the apparatus assigning controller 100 may provide a data sharing function between the servers 200. Moreover, the peripheral devices may include a graphics processing unit (GPU), a general-purpose computing on graphics processing unit (GPGPU), a non-volatile memory express (NVMe), a solid state disk (SSD), a network interface controller (NIC), a field-programmable gate array (FPGA), a redundant array of independent disk (RAID) or any other similar device or a combination thereof. For example, if each of the peripheral devices supports a single root I/O virtualization (SR-IOV) specification, the apparatus assigning controller 100 may virtualize the peripheral device into a plurality of virtual devices supporting the SR-IOV technique, and further includes one or a plurality of PCIe physical functions (PF), and each of the PCIe physical functions corresponds to at least one virtual function (VF), where the virtual functions may serve as virtual machines for utilization and classification. Moreover, the peripheral devices complied with the SR-IOV specification can be converted into peripheral devices of multiple root I/O virtualization (MR-IOV) for utilization. For example, one physical function can be correspondingly divided into 64 virtual functions. Alternatively, the peripheral devices may include a plurality of physical devices directly providing physical functions.

The communication interface 110 may include a plurality of PCIe buses. The PCIe buses may include a plurality of connection ports for high-speed communication transmission, and the connection ports are complied with the PCIe standard.

In the present embodiment, the communication interface can be coupled to the servers 200 through cables, so as to provide a data transmission function between the routing apparatus 120 and the servers 200. However, the coupling method between the apparatus assigning controller 100 and the serves 200 can be determined according to the transmission interface adopted in the embodiment, which is not limited by the invention.

The routing apparatus 120 belongs to a network apparatus. The routing apparatus 120 is a bus protocol communication chip. In the present embodiment, the routing apparatus 120 is configured to provide a data transfer mechanism such as routing, transfer, transmitting, etc., of data information and a data transfer path. Moreover, the routing apparatus 120 provides the aforementioned data transfer mechanism according to the PCIe communication protocol.

The servers 200 can be rack-mounted or tower-type physical servers, desktop computers, laptops, etc., that has a central processing unit (CPU). In the present embodiment, when the servers 200 are connected to the apparatus assigning controller 100 through the communication interface 110, the apparatus assigning controller 100 assigns the routing apparatus 120 to the servers 200, such that the server 200 may share data with each other. In other words, the routing apparatus 120 is configured to provide the data transfer path between the servers 200, such that the servers 200 may share data with each other based on the PCIe communication protocol. Therefore, the servers 200 are unnecessary to implement data sharing through a transmission control protocol/Internet protocol (TCP/IP). The servers 200 may implement data sharing through the PCIe buses and the routing apparatus 120 in the apparatus assigning controller 100.

To be specific, FIG. 2 is a schematic diagram of an example of an apparatus assigning controller according to an embodiment of the invention. Referring to FIG. 2, the apparatus assigning controller 300 includes a communication interface 310 and a routing apparatus 320. The communication interface 110 is configured to respectively connect a plurality of external servers (e.g., 410, 420 and 430). In the present embodiment, the communication interface 310 may include connection ports 311, 312, 313. The routing apparatus 320 includes a network interface card direct memory access (NIC DMA) module 321. The NIC DMA module 321 can also be referred to as a PCIe over TCP/IP module. The servers 410, 420, 430 respectively include access driving modules 411, 421, 431. In the present embodiment, the servers 410, 420, 430 can be respectively connected to the connection ports 311, 312, 312 of the communication interface 310 through cables, and share data through the PCIe buses in the apparatus assigning controller 300. Namely, the access driving modules 411, 421, 431 can be respectively connected to the NIC DMA module 321 of the routing apparatus 320, and execute a data sharing operation between the serves 410, 420, 430 according to the PCIe communication protocol. For example, when the servers 410, 420, 430 want to transmit data to each other, the servers 410, 420, 430 respectively execute the access driving modules 411, 421, 431 to implement data transfer through the NIC DMA module 321.

In an embodiment of the invention, the NIC DMA module 321 and the access driving modules 411, 421, 431 package the data information to be shared into packet-type data information according to the Internet protocol, and package the packet-type data information into PCIe-type data information according to the PCIe communication protocol. Then, the NIC DMA module 321 may transmit the data information to the apparatus assigning controller 300 through cables and the connection ports 311, 312, 313. The apparatus assigning controller 300 then transmits the data information to the NIC DMA module 321 through the PCIe buses. The NIC DMA module 321 then transfers or transmits the data information to a destination through the PCIe buses. In the present embodiment, the NIC DMA module 321 may respectively transfer or transmit the data information according to addresses, instructions or control signals provided by the access driving modules 411, 421, 431. In other words, the routing apparatus 320 may package the data of the TCP/IP in the PCIe communication protocol, such that the data is adapted to be transmitted from one server to another server in a network formed according to the PCIe communication protocol.

In detail, it is assumed that the server 410 wants to transmit data D1 to the server 420, the access driving module 411 of the server 410 first packages the data D1 into network data D2 complied with an Internet protocol (for example, TCP/IP), and then packages the network data D2 into bus data D3 complied with a bus transmission packet protocol. The access driving module 411 transmits the bus data D3 to the buses on the apparatus assigning controller 300. The NIC DMA module 321 in the apparatus assigning controller 300 transfers the bus data D3 to the destination server 420. After the access driving module 421 in the server 420 receives the bus data D3, the access driving module 421 first unpacks a bus protocol packet pattern, and then unpacks a TCP/IP packet pattern to obtain and read the data D1.

In an embodiment of the invention, the servers 410, 420, 430 may respectively include a central processing unit and a memory, where the memories of the servers 410, 420, 430 can be respectively used for storing the access driving modules 411, 421, 431. When the servers 410, 420, 430 want to execute the data sharing operation the central processing units of the 410, 420, 430 respectively execute the access driving modules 411, 421, 431 in the memories to drive the NIC DMA module 321 of the routing apparatus 320 to implement data sharing between the servers. In the present embodiment, the routing apparatus 320 is a peripheral device used for transferring data. The NIC DMA module 321 can be implemented by software or firmware. For example, the routing apparatus 320 may include a central processing unit and a memory, where the memory is configured to store the NIC DMA module 321. The routing apparatus 320 executes the NIC DMA module 321 by using the central processing unit or by using the access driving modules 411, 421, 431 of the servers, so as to implement a transmitting function and a receiving function of the data information. For another example, the NIC DMA module 321 can also be embedded into the apparatus assigning controller 300 or the routing apparatus 320 in a firmware manner, and can be driven by the access driving modules 411, 421, 431 to execute the transmitting and the receiving functions of the data information.

For example, it is assumed that the server 410 wants to share data information to the server 420. The server 410 executes the access driving module 411 to transmit the data information to be shared to a predetermined data buffer, and provides an address to the NIC DMA module 321 to drive the NIC DMA module 321. In this way, the server 410 may transmit the data information to the NIC DMA module 321 in the routing apparatus 320 through the connection port 311 according to the PCIe communication protocol. The NIC DMA module 321 then transfers the received data information to the destination server 420 through the connection port 312.

Moreover, since those skilled in the art can learn enough instructions and recommendations for device features related to the apparatus assigning controller and the servers of the present embodiment from the descriptions of the embodiments of FIG. 1, detailed description thereof is not repeated.

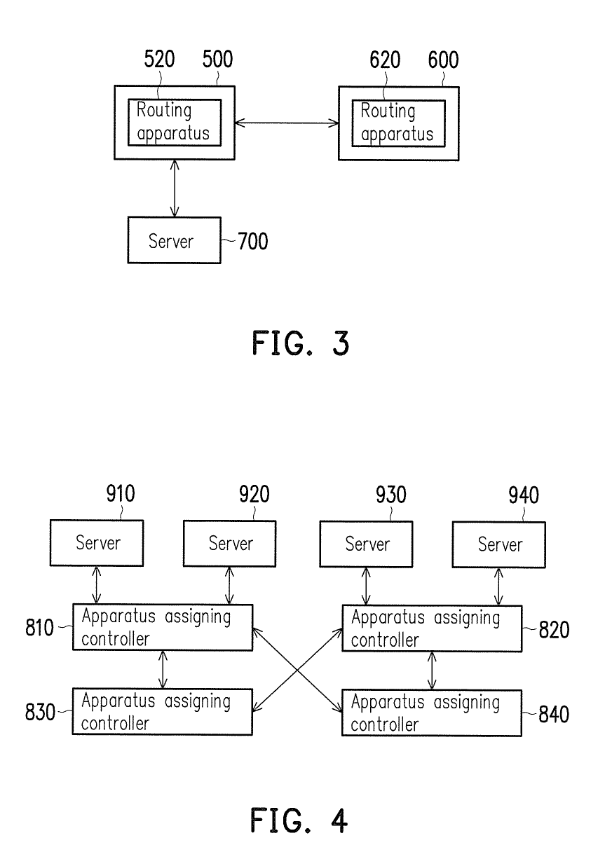

FIG. 3 is a block diagram of an apparatus assigning controller according to another embodiment of the invention. Referring to FIG. 3, the apparatus assigning controller 500 can be connected to another apparatus assigning controller 600 through a communication interface, and a server 700 connected to the apparatus assigning controller 500 may transmit data information to a server 800 connected to the apparatus assigning controller 600 through the apparatus assigning controller 500.

To be specific, in the present embodiment, the routing apparatuses 520 and 620 can be connected to each other through the communication interfaces in the apparatus assigning controllers 500, 600 or directly through a cable, so that the server 700 may transmit the data information according to respective Internet protocol (IP) addresses of the routing apparatuses 520 and 620. In the present embodiment, the IP address can be a host ID or a PCIe switch ID. The host ID of the routing apparatus can be a unique PCIe switch serial number in a register of the routing apparatus. The routing apparatuses 520, 620 may execute a function of a management console and a port mapping function. The routing apparatuses 520, 620 may assign the received data information, or transfer the data information to be shared by the server to other routing apparatus or server. Namely, the server 700 may perform the data sharing operation through the routing apparatuses 520, 620 according to the PCIe communication protocol.

The so-called “port mapping function” refers to that the routing apparatuses (for example, the routing apparatuses 520, 620 of FIG. 3) may record a host ID of each of the servers (for example, a network address, a unique PCIe serial number in a register of the server, a port number of the server connected to the routing apparatus), a PCIe apparatus assigning controller address (for example, a unique PCIe serial number in a register of the PCIe apparatus assigning controller, a chipset port number) of the routing apparatuses 520, 620 corresponding to the server, and a resource of the server or the routing apparatuses 520, 620 (for example, a resource to be sent to the PCIe apparatus assigning controller for central management), and collect the data (the PCIe apparatus assigning controller address, the host ID and the resource) to form a routing table. In this way, the routing apparatuses may determine a source address and a destination address of the received packets according to the routing table. The “port mapping function” is similar to a routing technique in TCP/IP, such as network address translation (NAT).

In FIG. 3, since there are two routing apparatuses 520 and 620 in the communication network, one of the two routing apparatuses 520 and 620 (for example, the routing apparatus 520) may implement the routing function (or referred to as the “port mapping function”). Namely, the routing apparatus 520 may serve as a main control device, and the other routing apparatus (the routing apparatus 620) may serve as a backup device to implement packet routing through TCP/IP in PCIe. For example, when the routing apparatus 520 serves as the main control device, the server 700 may transmit the data information to be shared to the routing apparatus 520. The routing apparatus 520 may perform port mapping to its own IP address or an IP address of the routing apparatus 620 of the destination of the data information to be shared by the server 700, so as to assign or guide the data information received by the routing apparatus 520 to the routing apparatus 620 of the destination. Namely, through the apparatus assigning controller 500, the server 700 may transmit the data to be shared to the apparatus assigning controller 600 connected to the apparatus assigning controller 500. Moreover, in an embodiment of the invention, the apparatus assigning controller 600 can be further connected to a plurality of peripheral devices, for example, central processing units or flash memories, etc. Therefore, the server 700 may transmit the data to be shared to the peripheral devices of the routing apparatus 620 through the routing apparatus 520, or receive data to be shared by the peripheral devices of the routing apparatus 620 according to the aforementioned data transmission mechanism.

Moreover, since those skilled in the art can learn enough instructions and recommendations for device features related to the apparatus assigning controller and the servers of the present embodiment from the descriptions of the embodiments of FIG. 1 and FIG. 2, detailed description thereof is not repeated.

FIG. 4 is a schematic diagram of an example of an apparatus assigning controller according to another embodiment of the invention. Referring to FIG. 4, servers 910, 920 are respectively connected to an apparatus assigning controller 810, and may share data with each other through a routing apparatus of the apparatus assigning controller 810 according to the PCIe communication protocol by using the apparatus assigning controller 810. Servers 930, 940 are respectively connected to an apparatus assigning controller 820, and may share data with each other through a routing apparatus of the apparatus assigning controller 820 according to the PCIe communication protocol by using the apparatus assigning controller 820. In the present embodiment, the apparatus assigning controllers 810, 820, 830, 840 are connected to each other through the respective communication interfaces or directly through cables. In the present embodiment, the apparatus assigning controllers 810, 820, 830, 840 can also be referred to as PCIe routing apparatuses.

For example, in the present embodiment, when the server 910 wants to share data to the server 940, the server 910 may transmits data information through a data transfer path established between the apparatus assigning controllers 810, 820. Namely, the apparatus assigning controller 810 may serve as a main control device, and the server 910 may transmit the data information to be shared to the routing apparatus of the apparatus assigning controller 810. The routing apparatus of the apparatus assigning controller 810 may perform port mapping to its own IP address or an IP address of the routing apparatus of the destination of the data information to be shared by the server 910, such that the apparatus assigning controller 810 assigns or guides the data information received by the routing apparatus from the server 910 to the routing apparatus of the destination, so as to further transmit the data information to the server 940 through the apparatus assigning controller 820.

For another example, in an embodiment of the invention, the apparatus assigning controllers 830 and 840 can be further connected to a plurality of peripheral devices. When the server 920 wants to share data to the peripheral devices connected to the apparatus assigning controllers 830 and 840, the server 920 transmit data information through a data transfer path established between the apparatus assigning controller 810 and the apparatus assigning controllers 830 and 840. Alternatively, the server 920 may receive data to be shared by the peripheral devices of the apparatus assigning controllers 830 and 840 according to the aforementioned data transfer mechanism.

Moreover, since those skilled in the art can learn enough instructions and recommendations for device features related to the apparatus assigning controller and the servers of the present embodiment from the descriptions of the embodiment of FIG. 3, detailed description thereof is not repeated.

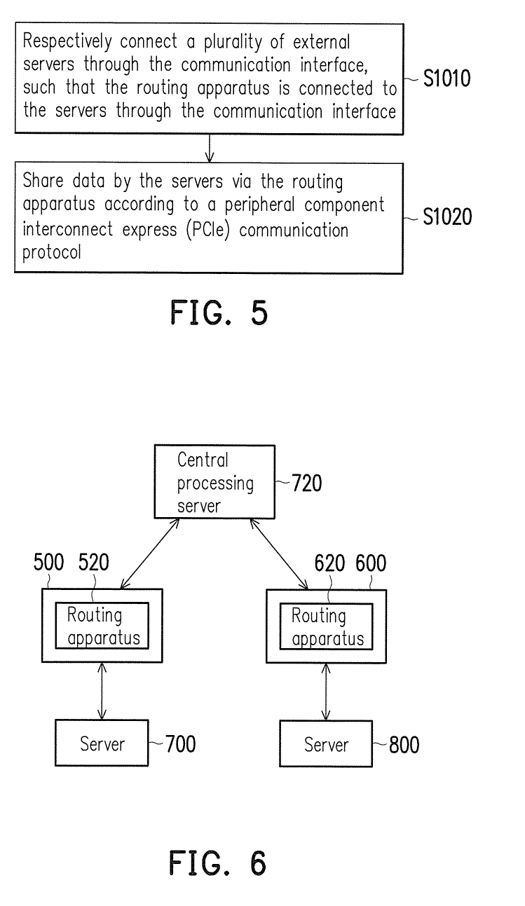

FIG. 5 is a flowchart illustrating a data sharing method according to an embodiment of the invention. Referring to FIG. 1 and FIG. 5, the data sharing method of the present embodiment is at least adapted to the apparatus assigning controller 100 and the server 200 of FIG. 1. In step S1010, the apparatus assigning controller 100 is respectively connected to a plurality of external servers 200 through the communication interface 110, such that the routing apparatus 120 is connected to the servers 200 through the communication interface 110. In step S1020, the apparatus assigning controller 100 makes the serves 200 to share data through the routing apparatus according to the PCIe communication protocol.

Moreover, since those skilled in the art can learn enough instructions and recommendations for device features related to the apparatus assigning controller and the servers and the data sharing method of the present embodiment from the descriptions of the embodiments of FIG. 1 and FIG. 2, detailed description thereof is not repeated.

FIG. 6 is a block diagram of an apparatus assigning controller according to still another embodiment of the invention. Referring to FIG. 6, a difference between FIG. 6 and FIG. 3 is that the apparatus assigning controller 500 and the other apparatus assigning controller 600 are connected to a central processing server 720 other than directly connect to each other. The server 700 connected to the apparatus assigning controller 500 may transmit data information with a server 800 connected to the apparatus assigning controller 600 through the apparatus assigning controller 500 and the central processing server 720. In this way, the central processing server 720 is used for implementing the port mapping function of the routing apparatuses 520 and 620, such that the servers 700 and 800 may communicate with each other.

In summary, in the apparatus assigning controller having a data sharing function and the data sharing method of the invention, when the servers wants to perform a data sharing operation, the data transfer path for sharing data can be provided between the servers according to the PCIe communication protocol. Therefore, the servers may drive or connect the NIC DMA of the routing apparatus by using the access driving modules, and package the data information to be shared into the PCIe-type data information to implement data information sharing. In other words, it is unnecessary to additionally set related hardware (for example, a network card, a network hole) of the Internet protocol between the servers to implement data transmission, but the apparatus assigning controller is directly adopted to transmit data according to the PCIe communication protocol, so as to save construction of related hardware of the Internet protocol in the servers, and since a transmission rate of the PCIe communication protocol is faster than a transmission rate of the Internet protocol, the transmission rate and bandwidth of data information transmitted between the servers are effectively enhanced. Moreover, based on the aforementioned feature of data transmission, the apparatus assigning controller of the invention can be further connected to another apparatus assigning controller, such that the servers may share data with servers connected to the another apparatus assigning controller according to the PCIe communication protocol and/or through the port mapping function between the apparatus assigning controller and the another apparatus assigning controller.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An apparatus assigning controller, comprising:
a communication interface, configured to respectively connect a plurality of external servers; and
a routing apparatus, connected to the communication interface, and configured to provide a data transfer path between the servers, so as to connect the routing apparatus to the servers through the communication interface,
wherein the servers share data with each other via the routing apparatus according to a peripheral component interconnect express (PCIe) communication protocol.

2. The apparatus assigning controller as claimed in claim 1, wherein the routing apparatus comprises a network interface card direct memory access module, and the servers respectively comprise:
an access driving module, configured to connect the network interface card direct memory access module of the routing apparatus, so as to execute a data sharing operation between the servers according to the PCIe communication protocol.

3. The apparatus assigning controller as claimed in claim 2, wherein the network interface card direct memory access module and the access driving modules package data information to be shared into network protocol data information according to the PCIe communication protocol, and transmit bus packet-type data information according to the PCIe communication protocol.

4. The apparatus assigning controller as claimed in claim 1, wherein the routing apparatus is a PCIe apparatus configured to perform data transmission of at least one data information with the communication interface according to an Internet protocol and the PCIe communication protocol.

5. The apparatus assigning controller as claimed in claim 1, wherein the communication interface and the servers transmit data information according to the PCIe communication protocol.

6. The apparatus assigning controller as claimed in claim 1, wherein the routing apparatus packages data of an Internet protocol in the PCIe communication protocol, such that the data is adapted to be transmitted from one server to another server in a network formed according to the PCIe communication protocol.

7. The apparatus assigning controller as claimed in claim 1, wherein the apparatus assigning controller is connected to another apparatus assigning controller through the communication interface, and the servers perform data transmission of at least one data information with the another apparatus assigning controller through the apparatus assigning controller.

8. The apparatus assigning controller as claimed in claim 7, wherein the routing apparatus is connected to a routing apparatus of the another apparatus assigning controller, and is configured to provide another data transfer path between the servers and a plurality of servers of the another apparatus assigning controller, and the servers perform data transmission of at least one data information according to an Internet protocol address of the routing apparatus and an Internet protocol address of the routing apparatus of the another apparatus assigning controller.

9. The apparatus assigning controller as claimed in claim 8, wherein the servers and the servers of the another apparatus assigning controller share data with each other through the routing apparatus and the routing apparatus of the another apparatus assigning controller according to the PCI communication protocol.

10. The apparatus assigning controller as claimed in claim 8, wherein the servers and the servers of the another apparatus assigning controller share data with each other through a port mapping function between the apparatus assigning controller and the another apparatus assigning controller.

11. A data sharing method, adapted to an apparatus assigning controller comprising a communication interface and a routing apparatus, the data sharing method comprising:
respectively connecting a plurality of external servers through the communication interface, such that the routing apparatus is connected to the servers through the communication interface; and
sharing data by the servers via the routing apparatus according to a peripheral component interconnect express (PCIe) communication protocol.

12. The data sharing method as claimed in claim 11, wherein the apparatus assigning controller comprises a network interface card direct memory access module, and each of the servers comprises an access driving module, and
the step of connecting the routing apparatus to the servers through the communication interface comprises:
executing a data sharing operation between the servers according to the PCIe communication protocol through the access driving module in each of the servers and the network interface card direct memory access module of the routing apparatus.

13. The data sharing method as claimed in claim 12, wherein the step of executing the data sharing operation between the servers according to the PCIe communication protocol comprises:
packaging data information to be shared into at least one packet-type data information according to an Internet protocol, and packaging the at least one packet-type data information into at least one PCIe-type data information according to the PCIe communication protocol.

14. The data sharing method as claimed in claim 11, wherein the routing apparatus is a PCIe apparatus, and is configured to transfer at least one data information between the servers according to an Internet protocol and the PCIe communication protocol.

15. The data sharing method as claimed in claim 11, further comprising:
connecting another apparatus assigning controller through the communication interface, wherein the servers perform data transmission of at least one data information with the another apparatus assigning controller through the apparatus assigning controller.

16. The data sharing method as claimed in claim 15, wherein the step of connecting the another apparatus assigning controller through the communication interface comprises:
performing data transmission of the at least one data information according to an Internet protocol address of the routing apparatus and an Internet protocol address of the routing apparatus of the another apparatus assigning controller.

17. The data sharing method as claimed in claim 16, wherein the step of performing data transmission of the at least one data information comprises:
sharing data through the routing apparatus and the routing apparatus of the another apparatus assigning controller according to the PCI communication protocol.

18. The data sharing method as claimed in claim 16, wherein the step of performing data transmission of the at least one data information comprises:
sharing data through a port mapping function between the apparatus assigning controller and the another apparatus assigning controller.
